(19) United States
(12) Patent Application Publication
(10) Pub. No.: US 2013/0004234 A1
(43) Pub. Date: Jan. 3, 2013

(54) FRICTION WELDING CONNECTION OF AT LEAST TWO STACKED PLATE-SHAPED COMPONENTS

(75) Inventor: Eberhard Christ, Tambach-Dietharz (DE)

(73) Assignee: EJOT GMBH & CO. KG, Bad Laasphe (DE)

(21) Appl. No.: 13/518,653

(22) PCT Filed: Dec. 20, 2010
(86) PCT No.: PCT/EP2010/070237

§ 371 Date: Aug. 28, 2012

(30) Foreign Application Priority Data
Dec. 22, 2009 (DE) 10 2009 059 270.9

(51) Int. Cl. F16B 11/00

(52) U.S. Cl. 403/265

(57) ABSTRACT

The invention relates to a friction welding connection having at least two stacked plate-shaped components (3, 4) of which the lower component (4) is made of a high-strength steel having a tensile strength of greater than 1000 megapascal, and the one or more upper components (3) are made of penetrable material, in particular light metal, being penetrated by a friction welding element (1, 2) connected to the lower component (4) by means of a friction weld connection (5, 6). The friction welding element (1, 2) is made of alloyed steel, having contents of carbon of 0.17% to 4.45%, chromium of 0.70% to 1.5% and molybdenum of 0.15% to 0.80%.

The invention relates to a friction welding connection of at least two stacked plate-shaped components of which the lower-most component is made of a high-strength steal having a tensile strength of greater than 1000 megapascal, and the one or more upper components are made of penetrable material, in particular light metal, being penetrated by a friction welding element connected to the lower-most component by means of a friction weld connection.

Such a friction welding connection is known from DE 10 2006 013 529.1. This friction welding connection comprises a lower component consisting of steal, and an upper component consisting of aluminum or plastics material. The friction welding element itself consists of steal which has entered into the desired friction welding connection with the lower component. Applications of such friction welding connections are arrangements of plates which, on the one hand, have a high rigidity and, on the other hand, are restive against environmental influences, as it is, for example, required for car body-sheet materials. Such an arrangement appears to be disclosed in the DE 10 2006 013 529 Al and DE 2009 006 775 A1. Therein, in the last-mentioned document, it is pointed in section 0027 to the fact that the first (upper) component consists of a softer material than the second (lower) component 40. For example, with the first component, it might be aluminum sheet metal, and, with the second component, it may be steal sheet material.

The invention is based on the objective to provide a material composition which corresponds to the imposed requirements and, therein, not only comprises the necessary characteristics with respect to the environment, but, furthermore, ensures the production of the friction welding connection with high security. This is effected, according to the invention, thereby that the friction welding element consists of alloyed steal with a content of carbon of 0.17% to 0.45%, of chromium of 0.70% to 1.5% and of molybdenum of 0.15% to 0.80%. This may be, therein, the material grade 21CrMoV57 and 40CrMoV47, for example.

In this implementation of the friction welding connection, the material of the friction welding element plays a special role in particular since it should penetrate, on the one hand, without changes of its own the upper component through the plastification thereof, can easily rub through an eventual coating of the lower-most component and forms with the lower-most component a friction welding connection which is characterized by a particular durability and strength and lends, thereby, a very high strength to the plate composite by means of the friction welding connection. The connection material is, therefore, particularly suited for the production of automobile car bodies since it is particularly stable because of the use of the high strength steal and provides for the desired light weight construction.

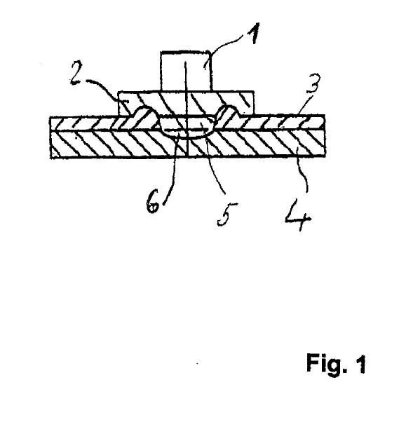

Such an embodiment suited for the present invention is, for example, shown in DE 10 2006 013 529, FIGS. 4, 5 and 6, wherein, however, only two plate-shaped components are provided for the composite material, i.e. a relatively soft material for the upper component and a high strength, hardened material for the lower material, (see section 0037 there).

The special composition of the friction welding element according to the invention lends to it the characteristic of practically not losing hardness in spite of the melting penetration through the one or the upper components themselves, whereby the penetration process itself can happen without disturbance. Also upon hitting of the friction welding element to the lower-most component, the first-mentioned element keeps its strength, in the first place, until the friction welding of the last-mentioned component to a large extent which leads, upon the actual friction welding of the lower-most component, also to the welding of the friction welding element. This is of particular importance for the secure process of manufacturing the friction welding connection, and, upon using a mangan and/or both containing steal ensured with process safety because of its low material strength as mentioned in the above-mentioned DE 10 2009 006 775 in section 0014 with respect to this use of the material.

An embodiment of the complete structure of the friction welding connection according to the invention is shown in the figure. The figure shows a bold 1 which is shown with respect to the combination of the upper plate 3 and the lower plate 4 with its connection element 2, wherein the plates 3 and 4 comprise the component thereby that the plates 3 and 4 are connected to each other by friction welding connection. As concerns plate 3, it is an aluminum plate, as concerns plate 4, it is a steal plate. The connection element 2 is penetrated with a projection 5 through the plate 2 during the friction welding process and has finally reached the plate 4 where, based on the rotation and the pressure, the friction welding zone 60 has resulted. Therein, the plate 3 is pressed against the plate 4 continuously through the friction welding element 2 with its shoulder 7 against the plate 4, in the end of the friction welding process, a strong connection between both plates 3 and 4 is produced by means of the friction welding connection 6.

1.-7. (canceled)

8. Friction welding connection having at least two stacked plated-shaped components (3, 4) of which the lower-most component (4) is made of a high-strength steal having a tensile strength of larger than 1000 megapascal, and the one or more upper components (3) are made of penetrable material, in particular light metal, being penetrated by a friction welding element (2) connected to the lower-most component (4) by means of a friction welding (6) characterized in that the friction welding element (2) consists of alloyed steal having contents of carbon of 0.17% to 0.45%, of chromium of 0.70% to 1.5% and molybdenum of 0.15% to 0.80%, whereby the friction welding element additionally contains vanadium with a content of 0.20% to 0.35% and comprises a tensile strength of larger than 1000 megapascal.

9. Friction welding connection according to claim 8, characterized in that the upper plates to be penetrated consist of plastics material.

10. Friction welding connection according to claim 8, characterized in that the lower-most plate consists of high strength steal which is not penetrated by the friction welding element.

11. Friction welding connection according to claim 8, characterized in that the lower-most plate is penetrated by the friction welding element.

12. Friction welding connection according to claim 8, characterized in that the friction welding element comprises a coating.
